(19) United States
(12) Patent Application Publication
(10) Pub. No.: US 2021/0136252 A1
(43) Pub. Date: May 6, 2021

(54) INFORMATION PROCESSING APPARATUS

(71) Applicant: Oki Data Corporation, Tokyo (JP)

(72) Inventor: Takafumi FUKUDA, Tokyo (JP)

(73) Assignee: Oki Data Corporation, Tokyo (JP)

(21) Appl. No.: 17/070,835

(22) Filed: Oct. 14, 2020

(30) Foreign Application Priority Data
Oct. 30, 2019 (JP) 2019-197355

(51) Int. Cl. H04N 1/44; H04N 1/32

(52) U.S. Cl. CPC H04N 1/4426; H04N 1/4433; H04N 1/32106

(57) ABSTRACT

An information processing apparatus according an embodiment may include: a data generation unit that generates first user information, first instruction information and second user information based on user inputs through an operation unit; a registration unit that registers the first user information, registers the first instruction information in association with the first user information, registers the second user information, and corresponds the registered first user information to the second user information; and a display control unit that displays on the display unit, in response to the generation of the first user information by the data generation unit, the first instruction information registered by the registration unit, and displays on the display unit, in response to the generation of the second user information by the data generation unit, the first instruction information associated with the first user information corresponded to the second user information.

### CROSS REFERENCE TO RELATED APPLICATIONS

This application claims priority based on 35 USC 119 from prior Japanese Patent Application No. 2019-197355 filed on Oct. 30, 2019, entitled “INFORMATION PROCESSING APPARATUS”, the entire contents of which are incorporated herein by reference.

### BACKGROUND

This disclosure may relate to an information processing apparatus capable of performing authentication of a user and registering operation instructions from the authenticated user.

There have been known multi-function peripheral devices (“MFP”) operable to scan an image, attach the scanned image to an electronic mail (“email”), and transmit the email with the scanned image to a specified destination. The multi-function peripheral devices may be configured to refer to transmission histories when specifying a destination (for example, Patent Document 1).

Patent Document 1: Japanese Patent Application Publication No. 2016-019051

### SUMMARY

Such multi-function peripheral devices may be expected to be convenient for users, and an information processing apparatus may be also expected to be more convenient for users.

It may be desirable to provide an information processing apparatus that can enhance the user convenience.

An aspect of an embodiment of the disclosure may be an information processing apparatus that may include an operation unit, a data generation unit, a registration unit, and a display control unit. The operation unit is configured to receive user operations. The data generation unit is configured, in response to an instruction from the operation unit based on a user operation, to generate first user information, first instruction information, and second user information. The registration unit is configured to register the first user information, register the first instruction information in association with the first user information, register the second user information, and correspond the registered first user information with the registered second user information. The display control unit is configure to display on the display unit, in response to the generation of the first user information by the data generation unit, the first instruction information registered by the registration unit, and display on the display unit, in response to the generation of the second user information by the data generation unit, the first instruction information associated with the first user information to which the registration unit has corresponded the second user information.

According to the aspect described above, the information processing apparatus can improve the user convenience, since the first instruction information associated with the first user information to which the registration unit has corresponded the second user information is displayed on the display unit in response to the generation of the second user information by the data generation unit.

### BRIEF DESCRIPTION OF DRAWINGS

FIG. 1 is a block diagram illustrating a view of a configuration example of a scan system according to an embodiment;

FIG. 2 is a block diagram illustrating a view of a configuration example of a multi-function peripheral device such as being illustrated in FIG. 1;

FIG. 3 is an explanation diagram illustrating a view of an example of a user management table such as being illustrated in FIG. 2;

FIG. 4 is an explanation diagram illustrating a view of an example of a transmission history table such as being illustrated in FIG. 2;

FIG. 5 is a block diagram illustrating a view of a configuration example of a software of the multi-function peripheral device such as being illustrated in FIG. 1;

FIG. 6 is a flowchart of an example of an operation of the multi-function peripheral device such as being illustrated in FIG. 1;

FIG. 7 is a diagram illustrating a view of a display screen displayed in the display operation unit such as being illustrated in FIG. 2;

FIG. 8 is a diagram illustrating a view of an example of a display screen displayed in the display operation unit such as being illustrated in FIG. 2;

FIG. 9 is a diagram illustrating a view of an example of a display screen displayed in the display operation unit such as being illustrated in FIG. 2;

FIG. 10 is a flowchart of an example of an operation of the multi-function peripheral device such as being illustrated in FIG. 1;

FIG. 11 is a diagram illustrating a view of an example of a display screen displayed in the display operation unit such as being illustrated in FIG. 2;

FIG. 12 is a diagram illustrating a view of another example of the user management table such as being illustrated in FIG. 2;

FIG. 13 is an explanation diagram illustrating another example of the transmission history table such as being illustrated in FIG. 2;

FIG. 14 is a flowchart of an example of an operation of the multi-function peripheral device such as being illustrated in FIG. 1;

FIG. 15 is a diagram illustrating an example of a display screen displayed in the display operation unit such as being illustrated in FIG. 2;

FIG. 16 is a diagram illustrating a view of an example of a display screen displayed in the display operation unit such as being illustrated in FIG. 2;

FIG. 17 is a diagram illustrating an example of a display screen displayed in the display operation unit such as being illustrated in FIG. 2;

FIG. 18 is a diagram illustrating a view of an example of a display screen displayed in the display operation unit such as being illustrated in FIG. 2;

FIG. 19 is a diagram illustrating a view of an example of a display screen displayed in the display operation unit such as being illustrated in FIG. 2; and

FIG. 20 is a flowchart of an example of an operation of the multi-function peripheral device such as being illustrated in FIG. 1.

### DETAILED DESCRIPTION

Descriptions are provided hereinbelow for one or more embodiments based on the drawings. In the respective drawings referenced herein, the same constituents are designated by the same reference numerals and duplicate explanation concerning the same constituents is omitted. All of the drawings are provided to illustrate the respective examples only.

### EMBODIMENTS

### Configuration Example

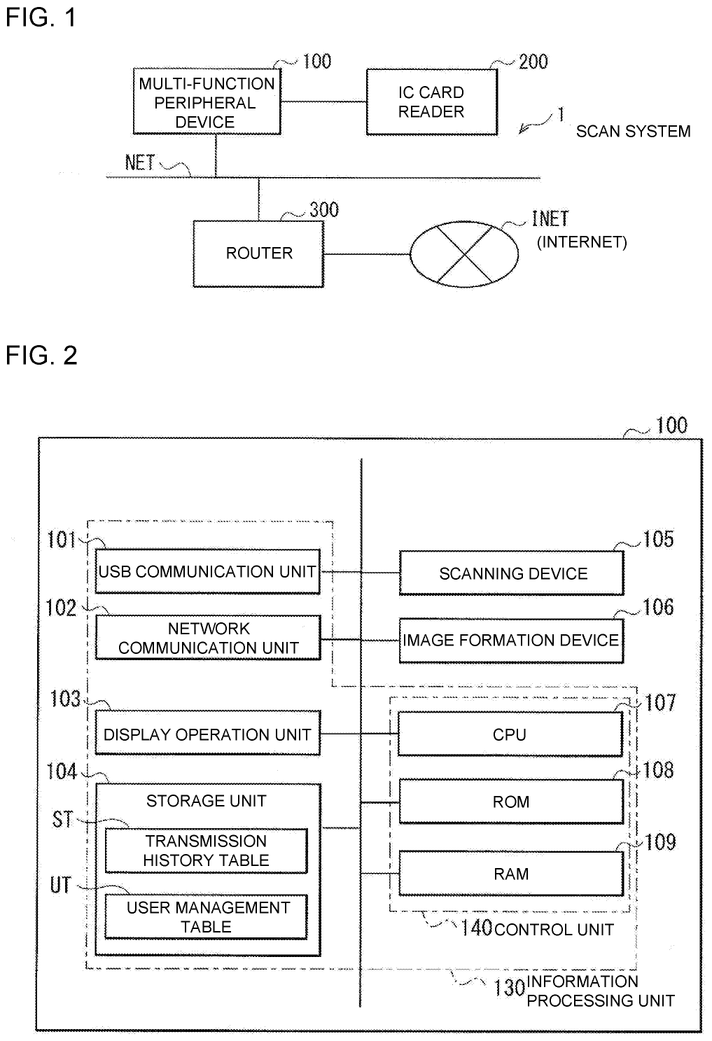

FIG. 1 is a diagram illustrating a view of a configuration example of a scan system 1 including an information processing apparatus according to an embodiment. The scan system 1 is a system for transmitting image files generated by scanning to information processing apparatuses connected to the system via the internet INET. The scan system 1 includes a multi-function peripheral device 100, an integrated circuit (IC) card reader 200 (or a smart card reader 200), and a router 300. The multi-function peripheral device 100 is connected to the IC card reader 200 through a universal serial bus (USB). The multi-function peripheral device 100 is connected to various devices via a network NET such as a wired LAN (Local Area Network) or a wireless LAN. Specifically, for example, the multi-function peripheral device 100 is connected to the router 300. The multi-function peripheral device 100 is connected to the internet INET via the network NET and the router 300 and thus is connected to the various apparatuses or devices such as a mail server (not illustrated) or the like connected to the internet INET.

The multi-function peripheral device 100 is configured to be execute operations such as scanning, printing, copying, and other operations. Specifically, the multi-function peripheral device 100 authenticates, based on a user operation, a user who tries to use the multi-function peripheral device 100, for example. When the user provides a document san instruction, the multi-function peripheral device 100 performs the scanning operation, based on the user instruction, to optically read (scan) an image on a recording medium such as a paper sheet and to generate image data, and then stores the image data as an image file in a predetermined format such as a PDF (Portable Document Format) or the like. Then, the multi-function peripheral device 100 performs, based on a user operation, a process of transmitting an email with the image file attached thereto to a specified destination (hereinafter may be referred to as a scan-to-mail process). Further, when the user provides a document print instruction the multi-function peripheral device 100 performs an image forming operation, based on the user instruction, to form an image on a recording medium using print job data received by the multi-function peripheral device 100 including various information regarding the printing. Further, when the user provides a document copy instruction, the multi-function peripheral device 100 performs a copying operation, based on the user instruction, to scan an image on the document to generate image data and form an image on a recording medium using the image data generated by the scanning operation.

The IC card reader 200 is configured to generate, when receiving a user operation, authentication information AUC which is information of an IC card (or a smart card) and transmit the authentication information AUC to the multi-function peripheral device 100. Specifically, when the user holds the IC card having the IC card information stored therein over the IC card reader 200, the IC card reader 200 reads the IC card information from the IC card based on the IC card standard. The IC card information is, for example, a 16-digit number that represents the serial number of the IC card. The IC card reader 200 transmits the read IC card information to the multi-function peripheral device 100 as the authentication information AUC to be used for the login. Note that an IC card may be referred to as a smart card.

The router 300 is configured to control transfer of various data in the Internet INET. Specifically, the router 300 transfers the email that is transmitted from the multi-function peripheral device 100, to the mail server through relay devices included in the Internet INET. The email is to be transmitted to a destination specified by the mail server.

First, a case that the user uses the multi-function peripheral device 100 when the user has his or her own IC card is described. In this case, the scan system 1 generates the authentication information AUC including the IC card information read by the IC card reader 200, and then transmits the authentication information AUC to the multi-function peripheral device 100. The multi-function peripheral device 100 uses the received authentication information AUC to authenticate the user by an IC card method. If the authentication information AUC read by the IC card reader 20 is not registered, the multi-function peripheral device 100 registers the authentication information AUC. If the user is successfully authenticated with the authentication information AUC read by the IC card reader 200, the multi-function peripheral device 100 performs, based on a user operation (a user input), operations such as a scanning operation, a scan-to-email processing, a printing operation, or the like. If the multi-function peripheral device 100 performs the scan-to-email processing, for example, the router 300 forwards the email from the multi-function peripheral device 100 to the mail server. The mail server transmits the email from the router 300 to a specified destination. The multi-function peripheral device 100 then registers the transmission history SH, which is information about the transmission process, including destination information AD, which is the destination of the email, in association with the authentication information AUC.

Next, a case that the same user uses the multi-function peripheral device 100 when the user does not have his or her own IC card is described. In this case, the multi-function peripheral device 100 generates authentication information AUP including a user name and a password entered by the user, and uses the authentication information AUP to authenticate the user by a password method. If the generated authentication information AUP is not registered, the multi-function peripheral device 100 registers the authentication information AUP. When the user is successfully authenticated with the generated authentication information AUP, the multi-function peripheral device 100 performs, based on a user operation, operations such as a scanning operation, a scan-to-email processing, a printing operation, or the like. When the multi-function peripheral device 100 performs the scan-to-mail processing, the router 300 forwards the email from the multi-function peripheral device 100 to the mail server. The mail server transmits the email from the router 300 to the specified destination. The multi-function peripheral device 100 then registers this transmission history SH in association with the authentication information AUP.

In a case where the same user uses the multi-function peripheral device 100 again when he or she has his or her own IC card, the multi-function peripheral device 100 similarly authenticates the user based on the authentication information AUC, which is the IC card information read by the IC card reader 200, and if the user's authentication is successful, performs operations such as a scanning operation, a scan-to-email processing, printing operation or the like based on a user operation. When the multi-function peripheral device 100 performs the scan-to-mail processing, the user can specify a destination(s) from one or more transmission histories SH that the user has executed in the past, upon sending an email. Specifically, the multi-function peripheral device 100 displays, based on a user operation, one or more past transmission histories SH done by the user same as the user identified by the authentication information AUC currently used for the authentication (currently being authenticated). In other words, the multi-function peripheral device 100 can display one or more transmission histories SH associated with the authentication information AUC and the authentication information AUP of the same user as the user identified by the authentication information AUC currently used for the authentication (currently being authenticated), and can select an email address(es) based on a user operation by referring the displayed one or more the transmission histories SH, so at to send an email to the selected address(es). The multi-function peripheral device 100 registers the transmission history SH for sending this email(s) in association with the authentication information AUC currently used for the authentication. This allows the scan system 1 to improve the user convenience.

FIG. 2 illustrates a configurational diagram of a configuration example of the multi-function peripheral device 100. The multi-function peripheral device 100 includes a scanning device 105, an image formation device 106, and an information processing unit 130.

The scanning device 105 is configured to perform, based on an instruction from a scan control unit 124 (described later), a scanning operation to optically read an image on a recording medium and generate image data.

The image formation device 106 is configured to perform, based on an instruction from an image formation control unit 125 (described later), an image forming operation to form an image on a recording medium.

The information processing unit 130 is configured to execute various processes in the multi-function peripheral device 100. The information processing unit 130 includes a USB communication unit 101, a network communication unit 102, a display operation unit 103, a storage unit 104, and a control unit 140 (or a controller).

The USB communication unit 101 is configured to transmit and receive data to and from the IC card reader 200 via a USB cable.

The network communication unit 102 is configured to transmit and receive data to and from various devices connected to the network. The network communication unit 102 includes, for example, a network interface card (NIC).

The display operation unit 103 is configured to receive a user operation and display various matters such as an operation state of the multi-function peripheral device 100 based on an instruction from the display operation control unit 112 (described later). The display operation unit 103 includes, for example, a touch panel, various buttons, a liquid crystal display, various indicators, and/or the like.

The storage unit 104 is configured to store various data such as various settings used in the multi-function peripheral device 100. The storage unit 104 is configured to include, for example, a non-volatile memory. Specifically, for example, the storage unit 104 stores a user management table UT and a transmission history table ST.

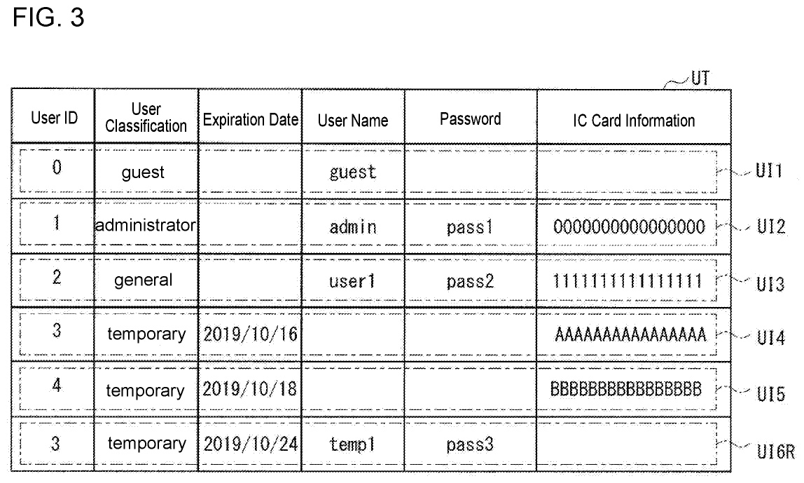

FIG. 3 is an explanation diagram illustrating an example of the user management table UT. The user management table UT includes one or more pieces of user management information UI each of which is various information about a user (in this example, user management information UI1 to UI5, UI6R). The user management information UI includes, for example, information about “User ID”, “User Classification”, “Expiration Date”, “User Name”, “Password”, and “IC Card Information”. The “User ID” is an identifier to identify the user management information UI. In this example, the data in the “User ID” is a numerical value, and when new user management information UI is added, the numerical value of the “User ID” of the new user management information UI is set to a value that a numerical value of +1 is added to largest value of the user ID in the user management table UT. The largest value of the user ID is a maximum integer that can be expressed in 32 bits in this example, and is sufficiently large, so that the cyclic processing is not performed. The “User Classification” is an identifier indicating a user category of the user management information UI, and “guest”, “administrator”, “general”, or “temporary” is registered as the data of the “User Classification”. The “guest” indicates that the user management information UI is used by a user other than an administrator who manages the multi-function peripheral device 100 in a case where the multi-function peripheral device 100 performs authentication by a non-authentication method that does not use authentication information. The “administrator” indicates that the user management information UI is used by the administrator. The “general” indicates that the user management information UI is used by a user who is authorized by the administrator. The “temporary” indicates that the user management information UI is used by a user other than the administrator in a case where the multi-function peripheral device 100 authenticates by the IC card method or the password method. The “Expiration Date” is an identifier indicating the expiration date of the user management information UI. The “User Name” is an identifier indicating a name of the user and the data in the “User Name” is arbitrary character information indicating the name of the user. The “Password” is an identifier indicating a password associated with the “User Name” and the data in the “Password” is arbitrary character information indicating the password. The “IC Card Information” is an identifier indicating identification information of the IC card and the data in the “IC Card Information” is a 16-digit numerical value that represents the serial number of the IC card. In each of the user management information UI, “NULL” indicating that there is no data is registered if no data is stored in one of the “Expiration Date”, the “User Name”, the “Password”, and the “IC Card Information”.

In the user management information UI1, the registered data of the “User ID”, the “User Classification”, and the “User Name” are “0”, “guest”, and “guest”, respectively. In the user management information UI2, the registered data of the “User ID”, the “User Classification”, the “User Name”, the “Password”, and the “IC Card Information” are “1”, “administrator”, “admin”, and “pass1”, and “0000000000000000”, respectively. In the user management information UI3, the registered data of the “User ID”, the “user Classification”, the “User Name”, the “Password”, and the “IC Card Information” are “2”, “general”, “user1”, “pass2”, and “111111111111111111”, respectively. In the user management information UI4, the registered data of the “User ID”, the “User Classification”, the “expiration date”, and the “IC Card Information” are “3”, “temporary”, “2019/10/16”, and “AAAAAAAAAAAAAAAA”, respectively. In the user management information UI5, the registered data the “User ID”, the “User Classification”, the “expiration date”, and the “IC Card Information” are “4”, “temporary”, “2019/10/18”, and “BBBBBBBBBBBBBBBBBB”, respectively. In the user management information UI6R, the registered data of the “User ID”, the “User Classification”, the “Expiration Date”, the “User Name” and the “Password” are “3”, “temporary”, “2019/10/24”, “temp1”, and “pass3”, respectively. In this example, each of the user management information UI4 and UI5 includes authentication information AUC, which is IC card information, and user management information UI6R includes authentication information AUP, which is a user name and password. In this example, the authentication information AUP of the user management information UI6R and the authentication information AUC of the user management information UI4 correspond to each other because they have the same user ID, and the user ID of the user management information UI4 and the user ID of the user management information UI6R are “3” respectively. In this example, the date stored in the “Password” is any character information indicating a user password, but it is not limited to this, and may be, for example, a hash value, which is a value converted from a string representing the password based on a hash function.

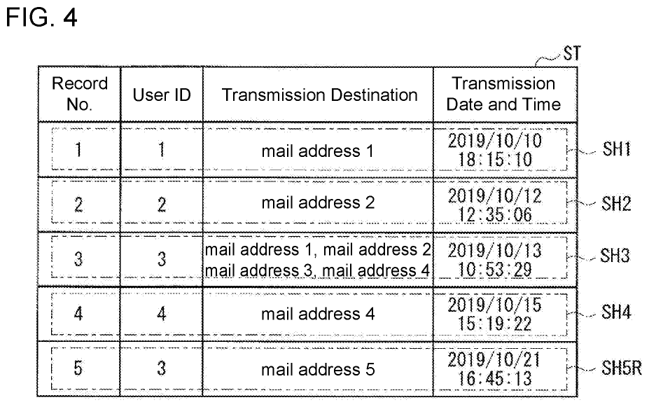

FIG. 4 is an explanatory diagram illustrating an example of the transmission history table ST. The transmission history table ST includes one or more transmission histories SH (transmission histories SH1 to SH4, SH5R in this example). Each of the transmission histories SH includes, for example, information about “Record No.”, “User ID”, “Transmission Destination”, and “Transmission Date and Time”. The “Record No.” is an identifier for uniquely identifying the transmission history SH. In this example, the “Record No.” is used as a sort key for acquiring the transmission history SH from the transmission histories SH of the latest registration dates and times. The “User ID” indicates an ID of the user who sent the email. The transmission history SH is associated with at least one of the authentication information AUC and the authentication information AUP of the user management information UI based on the “User ID”. The “Transmission Destination” indicates, for example, a mail address indicating the destination of the email. The “Transmission Date and Time” indicates the date and time when the multi-function peripheral device 100 transmitted the email.

In the transmission history SH1, the registered data of the “Record No.”, the “User ID”, the “Transmission Destination”, and the “Transmission Date and Time” are “1”, “1”, “mail address 1”, and “2019/10/10 18:15:10”, respectively. In the transmission history SH2, the registered data of the “Record No.”, the “User ID”, the “Transmission Destination”, and the “Transmission Date and Time” are “2”, “2”, “mail address 2”, and “2019/10/12 12:35:06”, respectively. In the transmission history SH3, the registered data of the “Record No.”, the “User ID”, the “transmission destination”, and the “Transmission Date and Time” are “3”, “3”, “mail address 1, mail address 2, mail address 3, and mail address 4”, and “2019/10/13 10:53:29”, respectively. In the transmission history SH4, the registered data of the “Record No.”, the “user ID”, the “Transmission Destination”, and the “Transmission Date and Time” are “4”, “4”, “mail address 4”, and “2019/10/15 15:19:22”, respectively. In the transmission history SH5R, the registered data of the “Record No.”, the “User ID”, the “Transmission Destination”, and the “Transmission Date and Time” are “5”, “3”, “mail address 5”, and “2019/10/21 16:45:13”, respectively. In this example, as illustrated in FIG. 3, the authentication information AUP of the user management information UI6R and the authentication information AUC of the user management information UI4 correspond to each other because the user ID thereof are the same. The user ID of the transmission history SH3 associated with the authentication information AUC of the user management information UI4 and the user ID of the transmission history SH5R associated with the authentication information AUP of the user management information UI6R are “3”, respectively.

The control unit 140 is configured to execute various programs to perform processing according to the programs. The functions of the control unit 140 may be realized, for example, by hardware or by software. In this example, the control unit 140 includes a CPU (Central Processing Unit) 107, a ROM (Read Only Memory) 108, and a RAM (Random Access Memory) 109. The CPU 107 is configured to execute various programs and control the overall operation of the multi-function peripheral device 100 based on the execution results. The ROM 108 is a non-volatile memory and is configured to store various programs to be executed by the CPU 107. The RAM 109 is a volatile memory, and is configured to temporarily store information to be used when the CPU 107 executes the various programs.

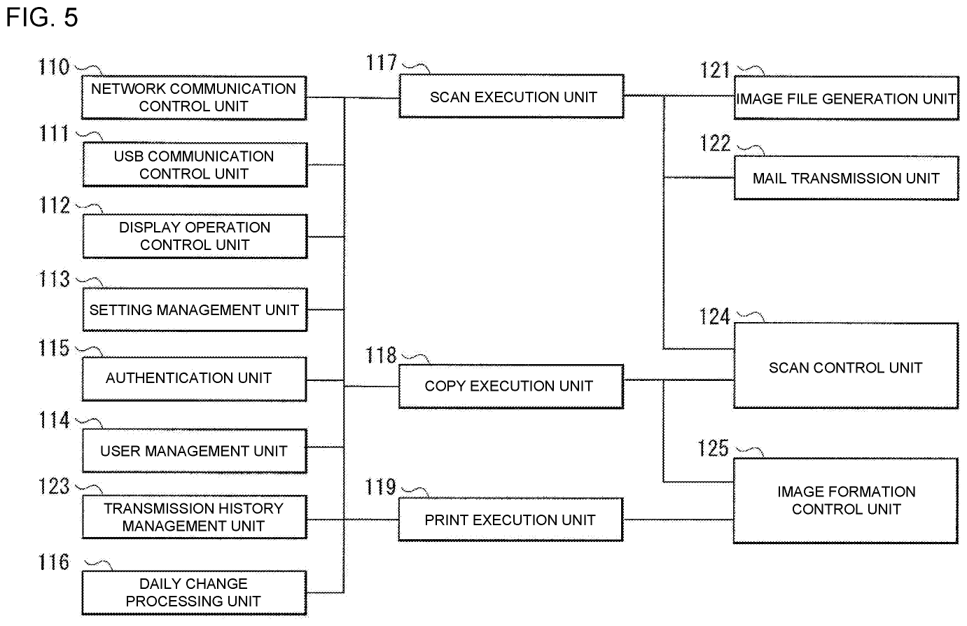

FIG. 5 is a configuration diagram illustrating an example of a software configuration in the multi-function peripheral device 100. The control unit 140 is configured to execute a network communication control unit 110, a USB communication control unit 111, a display operation control unit 112, a setting management unit 113, an authentication unit 115, a user management unit 114, a scan execution unit 117, a copy execution unit 118, a print execution unit 119, a scan control unit 124, an image file generation unit 121, a mail transmission unit 122, a transmission history management unit 123, an image formation control unit 125, and a daily change processing unit 116.

The network communication control unit 110 is configured to control the network communication unit 102 based on the TCP (Transmission Control Protocol)/IP (Internet Protocol) protocol. Specifically, for example, the network communication control unit 110 receives print job data via the network communication unit 102. Further, the network communication control unit 110 transmits an email via the network communication unit 102.

The USB communication control unit 111 is configured to control the USB communication unit 101 in accordance with the USB standard. Specifically, for example, the USB communication control unit 111 receives the authentication information AUC read by the IC card reader 200 via the USB communication unit 101. The USB communication control unit 111 then notifies the received authentication information AUC to the authentication unit 115.

The display operation control unit 112 is configured to notify each block of operation instructions based on the instruction from the display operation unit 103 and to control the display operation unit 103 to display various screens. The display operation control unit 112 generates the authentication information AUP based on the instruction from the display operation unit 103 (based on the user's input) and notifies the authentication unit 115 of the generated authentication information AUP. The display operation control unit 112 generates destination information AD based on the instruction from the display operation unit 103, and displays the generated destination information AD on the display operation unit 103.

The setting management unit 113 is configured to set setting information such as the IP address of the multi-function peripheral device 100 and the IP address of a mail server connected to the Internet INET, and manage the setting information.

The authentication unit 115 is configured to authenticate a user based on the operation instruction notified by the display operation control unit 112, the authentication information AUP notified by the display operation control unit 112, or the authentication information AUC notified by the USB communication control unit 111. Specifically, for example, when the multi-function peripheral device 100 authenticates a user, the authentication unit 115 determines the authentication method based on the operation instruction notified by the display operation control unit 112, the authentication information AUP notified by the display operation control unit 112, or the authentication information AUC notified by the USB communication control unit 111. When the authentication method is the IC card method, the authentication unit 115 determines whether the user management information UI that includes the IC card information same as the IC card information read by the IC card reader as the authentication information AUC exists in the user management table UT. When the authentication method is the password method, the authentication unit 115 determines whether the user management information UI that includes the user name same as the user name included in the received authentication information AUP exists in the user management table UT. When the user management information UI that includes the same user name as the user name of the received authentication information AUP exists in the user management table UT, the authentication unit 115 determines whether the password of the received authentication information AUP matches with the password included in the found user management information UI. If matched, the authentication unit 115 corresponds these two pieces of authentication information are to each other.

The user management unit 114 is configured to manage the user management information UI in the user management table UT based on the instruction from the authentication unit 115 and the daily change processing unit 116. Specifically, for example, the user management unit 114 sets the user ID used for the login to “0” when the authentication method is a non-authentication method. For example, the user management information UI1 illustrated in FIG. 3 has the user ID of “0” because the authentication method is a non-authentication method. When the authentication method is the IC card method and it is determined that no user management information that has an IC card information that matches with the IC card information as the authentication information AUC read by the IC card reader 200 exists in the user management table UT, the user management unit 114 registers, based on the instruction from the authentication unit 115, a new user management information UI that includes the read IC card information in the user management table UT. Then, the user management unit 114 obtains the user ID of the user management information UI, and updates the expiration date in the user management information UI. When the authentication method is the password method and the user name of the received authentication information AUP does not exist in the user management table UT, the user management unit 114 registers, based on the instruction from the authentication unit 115, a new user management information UI that includes the received authentication information AUP including the user name and the password in the user management table UT. Then, the user management unit 114 obtains the user ID of the new user management information UI that includes the authentication information AUP, and the user management unit 114 updates the expiration date in the user management table UT. When the authentication method is the password method and user management information that has a user name and a password matching with the user name and the password of the received authentication information AUP exists in the user management table UT, the user management unit 114 obtains, based on the instruction from the authentication unit 115, the user ID of the user management information UI. Then, the user management unit 114 updates the expiration date in the user management information. When the authentication method is the password method and there is user management information that matches with the user name in the received authentication information AUP but does not match with the password in the received authentication information AUP, in the user management table, the user management unit 114 sets the user ID currently used for the login to “−1” that indicates the user authentication is in error. The user management unit 114 also notifies the display operation control unit 112 of the user ID. The user management unit 114 obtains, based on the instruction from the daily change processing unit 116, the user ID of the user management information UI that includes the expiration date prior to the current date in the user management table UT. The user management unit 114 deletes, based on the instruction from the daily change processing unit 116, the user management information UI that includes the expiration date prior to the current date in the user management table UT. The user management unit 114 is also configured to update the user management table UT based on the instruction from the authentication unit 115.

The scan execution unit 117 is configured to control various processes about the scanning operation based on the operation instruction notified by the display operation control unit 112. Specifically, for example, the scan execution unit 117 controls the image file generation unit 121, the mail transmission unit 122, the transmission history management unit 123, and the scan control unit 124, based on the operation instruction notified by the display operation control unit 112.

The copy execution unit 118 is configured to control various processes about the copy operation based on the operation instruction notified by the display operation control unit 112. Specifically, for example, the copy execution unit 118 controls the scan control unit 124 and the image formation control unit 125 based on the operation instruction notified by the display operation control unit 112.

The print execution unit 119 is configured to control various processes about the image forming operation based on the operation instruction notified by the display operation control unit 112. Specifically, for example, the print execution unit 119 controls, based on the operation instruction notified by the display operation control unit 112, the image formation control unit 125 according to the print job data received by the network communication control unit 110 via the network communication unit 102.

The scan control unit 124 is configured to acquire, based on the instruction from the scan execution unit 117 and the copy execution unit 118, the image data by controlling the scanning operation in the scanning device 105. Specifically, for example, the scan control unit 124 controls the scanning device 105 to perform the scanning operation based on the instruction from the scan execution unit 117, so as to obtain the image data. The scan control unit 124 also controls the scanning device 105 to perform the scanning operation based on the instruction from the copy execution unit 118, so as to obtain the image data.

The image file generation unit 121 is configured to generate, based on the instruction from the scan execution unit 117, an image file of a predetermined format, for example, using the image data obtained by the scan control unit 124. The generated image file is stored in the storage unit 104.

The mail transmission unit 122 is configured, based on an instruction from the scan execution unit 117, to generate an email with the image file generated by the image file generation unit 121 as an attachment and to transmit the email to a destination specified based on a user operation.

The transmission history management unit 123 is configured to manage the transmission history SH in the transmission history table ST based on the instruction from the daily change processing unit 116 and the scan execution unit 117. Specifically, for example, when the mail transmission unit 122 transmits an email, the transmission history management unit 123 registers the transmission history SH in the transmission history table ST based on the instruction from the scan execution unit 117. The transmission history management unit 123 determines whether the number of records of the transmission histories SH that include the user ID same as the user ID currently used for the login (currently authenticated) in the transmission history table ST exceeds a specified value (a threshold). Then, if the number of records of the transmission histories SH that include the user ID same as the user ID currently used for the login exceeds the specified value, the transmission history management unit 123 deletes the transmission history SH that has the smallest record number among the transmission histories SH that include the user ID same as the user ID currently used for the login. The transmission history management unit 123 deletes, from the transmission history table ST, the transmission history SH that corresponds to the user management information UI that includes the expiration date prior to the current date, based on the instruction from the daily change processing unit 116. The transmission history management unit 123 updates the transmission history table ST based on the instruction from the authentication unit 115. The transmission history management unit 123 then notifies the display operation unit 103 of an update completion notification.

The image formation control unit 125 is configured to control the image forming operation in the image formation device 106 based on the instruction from the copy execution unit 118 and the print execution unit 119. Specifically, for example, the image formation control unit 125 controls, based on the instruction from the copy execution unit 118, the image formation device 106 to perform an image forming operation using the image data acquired by the scan control unit 124. The image formation control unit 125 controls, based on the instruction from the print execution unit 119, the image formation device 106 to perform the image forming operation using the print job data obtained by the print execution unit 119.

The daily change processing unit 116 is configured to instruct the user management unit 114 to update the user management table UT and instruct the transmission history management unit 123 to update the transmission history table ST at the timing when the multi-function peripheral device 100 is activated and at the timing when the date changes. Specifically, for example, the daily change processing unit 116 instructs the user management unit 114 to obtain the user ID of the user management information UI that includes the expiration date prior to the current date in the user management table UT. The daily change processing unit 116 instructs the user management unit 114 to delete, from the user management table UT, the user management information UI that includes the expiration date prior to the current date. In addition, the daily change processing unit 116 instructs the transmission history management unit 123 to delete, from the transmission history table ST, the transmission history SH that corresponds to the user management information UI that includes the expiration date prior to the current date.

Here, the information processing unit 130 and the IC card reader 200 may correspond to an example of an “information processing apparatus” in the disclosure. The display operation unit 103 and the IC card reader 200 may correspond to an example of an “operation unit” in the disclosure. The display operation control unit 112 and the IC card reader 200 may correspond to an example of a “data generation unit” in the disclosure. The user management unit 114, the daily change processing unit 116, and the transmission history management unit 123 may correspond to an example of a “registration unit” in the disclosure. The display operation control unit 112 may correspond to an example of a “display control unit” in the disclosure. The display operation unit 103 may correspond to an example of a “display unit” in the disclosure. One of the authentication information AUP and the authentication information AUC may correspond to an example of “first user information” and the other of the authentication information AUP and the authentication information AUC may correspond to an example of “second user information” in this disclosure.

[Operations and Effects]

Next, operations and effects of the scan system 1 according an embodiment is described below.

(Basic Operation)

First, referring to FIGS. 1, 2, and 5, a basic operation of the scan system 1 is described.

In the scan system 1, the multi-function peripheral device 100 authenticates a user who is going to use the multi-function peripheral device 100 based on a user operation. When a user carries his or her own IC card and tries to log in to the multi-function peripheral device 100, the IC card reader 200 reads IC card information from the IC card and generates authentication information AUC including the read IC card information, and then transmits the generated authentication information AUC to the multi-function peripheral device 100. The multi-function peripheral device 100 authenticates the user by the IC card method with the received authentication information AUC, and permits the login using the user ID of the user management information UI registered in the user management table UT, which is associated with the authentication information AUC. When the same user does not carry his or her own IC card and tries to log in to the multi-function peripheral device 100, the multi-function peripheral device 100 generates authentication information AUP, which is the user name and password entered by the user, and uses the authentication information AUP to authenticate the user by the password method, to permits the login using the user ID of the user management information UI registered in the user management table UT, which is associated with the authentication information AUP. If the user does not want to register a transmission history SH in the multi-function peripheral device 100, the multi-function peripheral device 100 receives a user operation to authenticate the user by a non-authentication method to permit the login using the user ID of the user management information UI whose user classification is a guest. In the multi-function peripheral device 100, when the user provides a document scan instruction through the display operation unit 103, the display operation control unit 112 notifies the scan execution unit 117 of various operation instructions based on the instruction from the display operation unit 103. The scan execution unit 117 controls various processes about the scanning operation based on the various operation instructions notified by the display operation control unit 112. The scanning device 105 then performs the scanning operation. When the user provides a document print instruction through the display operation unit 103, the display operation control unit 112 notifies the print execution unit 119 of various operation instructions based on the instruction from the display operation unit 103. The print execution unit 119 controls various processes about the image forming operation based on the operation instructions notified by the display operation control unit 112. The image formation device 106 then performs the image forming operation. When the user provides a document copy instruction through the display operation unit 103, the display operation control unit 112 informs the copy execution unit 118 of various operation instructions based on the instruction from the display operation unit 103. The copy execution unit 118 controls various processes about the copy operation based on the operation instructions notified by the display operation control unit 112. Then, the scanning device 105 performs the scanning operation and the image formation device 106 performs the image formation operation.

(Detailed Operation)

Next, the authentication process of the user of the multi-function peripheral device 100 is described in detail, followed by a detailed description of the scan-to-email process of the multi-function peripheral device 100, and finally, the daily change process of the multi-function peripheral device 100 is described in detail.

(User Authentication Process)

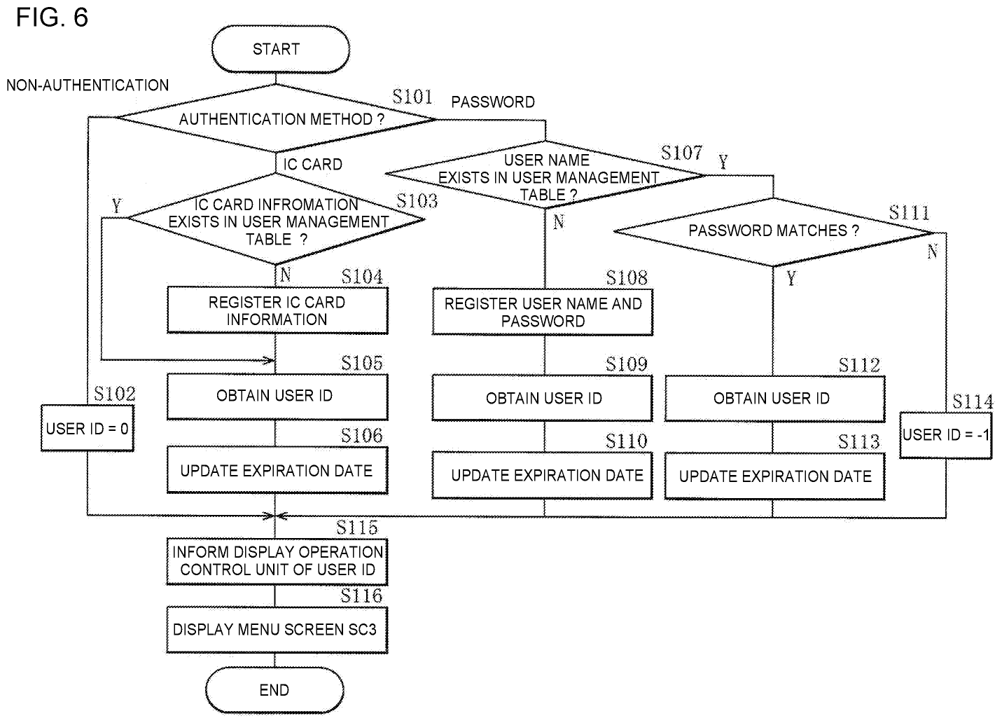

FIG. 6 is a diagram illustrating a view of an example of a user authentication process of the multi-function peripheral device 100. When the user tries to use the multi-function peripheral device 100, the display operation unit 103 displays a standby screen SC1 to prompt the user for authentication. The process begins when the display operation unit 103 or the IC card reader 200 of the multi-function peripheral device 100 receives a user operation. This operation is described in detail below.

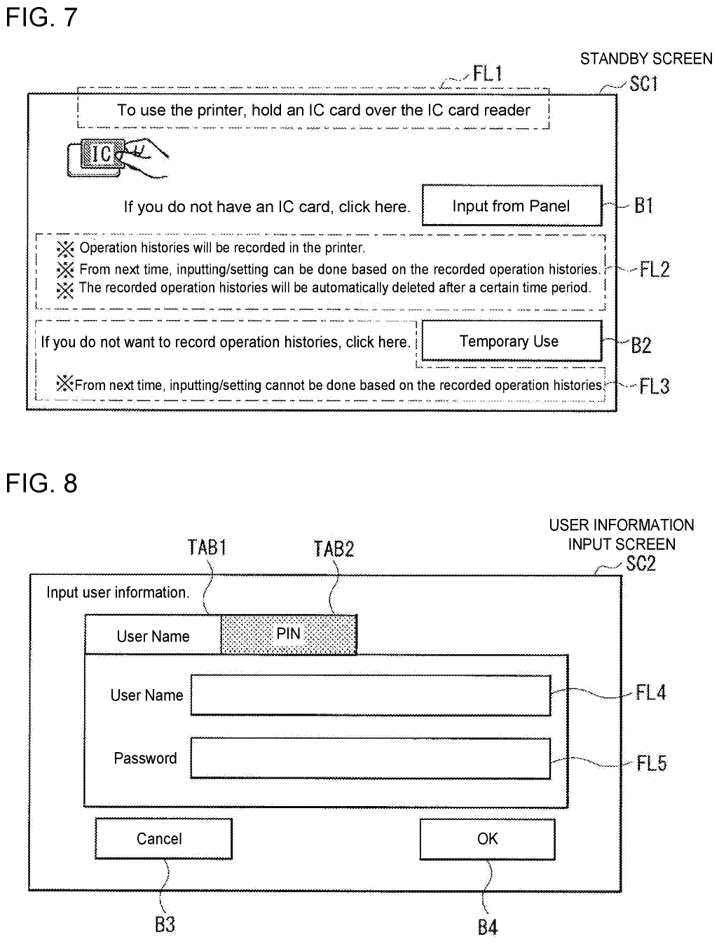

FIG. 7 is a diagram illustrating a view of an example of the standby screen SC1. The standby screen SC1 includes an information field FL1, an “Input from Panel” button B1, an information field FL2, a “Temporary Use” button B2, and an information field FL3. The information field FL1 is a field for prompting the user to enter the authentication information AUC by holding the IC card over the IC card reader 200. The “Input from Panel” button B1 is a button to display a user information input screen SC2 through which the authentication information AUP can be inputted when the user does not have an IC card. The information field FL2 is a field indicating that the multi-function peripheral device 100 registers the transmission history SH when the user logs in through the IC card reader or the user logs in through “Input from Panel” button B1. The “Temporary Use” button B2 is a button to log in to the multi-function peripheral device 100 in a non-authentication way. When the user logs in through the “Temporary Use” button B2 in the non-authentication way, user management information UI includes the user classification of “Guest” and the user ID of “0” (in this example, user management information UI1). The information field FL3 is a field indicating that the multi-function peripheral device 100 does not register the transmission history SH if the user logs in through the “Temporary Use” button B2 in the non-authentication way.

FIG. 8 is a diagram illustrating a view of an example of the user information entry screen SC2. The user information entry screen SC2 has a user name tab TAB1 a PIN tab TAB2, a user name field FL4, a password field FL5, a cancel button B3, and an OK button B4. The username tab TAB1 is a switch for displaying the username field FL4 and the password field FL5. The PIN tab TAB2 is a switch for displaying a field for inputting a PIN (Personal Identification Number), which is a four-digit number, for example. Because of the low security strength of the PIN, the user cannot operate the PIN tab TAB2 in this example. The user name field FL4 is a field to which a user name is to be inputted. The password field FL5 is a field to which a password is to be inputted. The cancel button B3 is used to cancel the entry of the user name and password and return to the standby screen SC1. The OK button B4 is a button for deciding to use the inputted user name and password as the authentication information AUP.

First, as illustrated in FIG. 6, the authentication unit 115 determines the authentication method based on the operation instruction notified by the display operation control unit 112, the authentication information AUP notified by the display operation control unit 112, or the authentication information AUC notified by the USB communication control unit 111 (step S101). Specifically, for example, when the IC card reader 200 receives a user operation (reads the IC card information from the IC card), the IC card reader 200 generates authentication information AUC, which is the IC card information, and transmits the authentication information AUC to the multi-function peripheral device 100. The USB communication control unit 111 then notifies the authentication information AUC to the authentication unit 115. When the authentication information AUC is notified to the authentication unit 115, the authentication method is the IC card method. When the display operation unit 103 receives a user operation on the “Enter from Panel” button B2 on the standby screen SC1, the display operation unit 103 displays the user information input screen SC2, receives a user operation through the user name field FL4 and the password field FL5 in the user information input screen SC2, and receives a user operation on the OK button B4. Then, the display operation control unit 112 generates authentication information AUP based on the instruction from the display operation unit 103, and notifies the authentication unit 115 of the authentication information AUP and the operation instruction in response to the OK button B4. When the authentication information AUP and the operation instruction are notified to the authentication unit 115 the authentication method is the password method. When the display operation unit 103 receives a user operation on the “Temporary Use” button B2 in the standby screen SC1, the display operation control unit 112 notifies the authentication unit 115 of the operation instruction on the “Temporary Use” button B2. When this operation instruction is notified to the authentication unit 115, the authentication method is the non-authentication method. When the authentication method is the non-authentication method (“non-authentication” in step S101), the user management unit 114 sets the user ID currently used for the login to “0” (step S102), which is the user ID of user management information UI1, and the process proceeds to Step S115.

When the authentication method is the IC card method (“IC card” in Step S101), the authentication unit 115 determines whether the IC card information same as the IC card information read by the IC card reader as the authentication information AUC exists in the user management table UT (Step S103). If the IC card information exists in the user management table UT (“Y” in step S103), the process proceeds to step S105.

When the IC card information does not exist in the user management table UT (“N” in step S103), the user management unit 114 registers the IC card information in the user management table UT based on an instruction from the authentication unit 115 (step S104). Specifically, for example, the user management unit 114 registers new user management information UI that includes the authentication information AUC (the IC card information) in the user management table UT. The “User Classification” is set to “temporary” and the “Expiration Date, the “User Name”, and the “Password” are set to “NULL”.

Next, the user management unit 114 obtains the user ID of the user management information UI that includes the authentication information AUC (Step S105).

Then, the user management unit 114 updates the expiration date in the user management table UT (Step S106). Specifically, for example, the user management unit 114 updates the expiration date of the user management information UI that includes the authentication information AUC to a date after a predetermined number of days. Here, the predetermined number of days is, for example, the number of days determined by the administrator in advance, which may be three days in this example. Then, the process proceeds to Step S115.

When the authentication method is the password method (“Password” in Step S101), the authentication unit 115 determines whether the user name same as the user name of the authentication information AUP exists in the user management table UT (Step S107). If the user name exists in the user management table UT (“Y” in step S107), the process proceeds to step S111.

If the user name does not exist in the user management table UT (“N” in step S107), the user management unit 114 registers the user name and the password in the user management table UT based on the instruction from the authentication unit 115 (step S108). Specifically, for example, the user management unit 114 registers new user management information UI that includes the authentication information AUP in the user management table UT. The user classification is set to “temporary” and the expiration date and the IC card information are set to “NULL”.

Next, the user management unit 114 obtains the user ID of the user management information UI that includes the authentication information AUP (step S109).

Next, the user management unit 114 updates the expiration date in the user management table UT (step S110). Specifically, for example, the user management unit 114 updates the expiration date of the user management information UI that includes the authentication information AUP to a date after the predetermined number of days. Then, the process proceeds to Step S115.

If the user name exists in the user management table UT (“Y” in step S107), the authentication unit 115 determines whether the password of the authentication information AUP matches with the password of the user management information UI that includes the user name same as the user name of the authentication information AUP (Step S111). If the passwords do not match with each other (“N” in step S111), the user management unit 114 sets the user ID currently used for the login to “−1” that indicates the user authentication is in error (step S114), and then the process proceeds to Step S115.

If the passwords match with each other (“Y” in step S111), the user management unit 114 obtains the user ID of the user management information UI that includes the authentication information AUP (step S112).

Next, the user management unit 114 updates the expiration date in the user management table UT (step S113). Specifically, for example, the user management unit 114 updates the expiration date of the user management information UI that includes the authentication information AUP to a date after the predetermined number of days. Then, the process proceeds to Step S115.

Next, the user management unit 114 informs the display operation control unit 112 of the user ID (step S115).

Next, the display operation control unit 112 controls, based on the user ID notified by the user management unit 114, the display operation unit 103 to display a menu screen SC3 displaying an operation menu in a logged-in state (step S116). The display operation unit 103 then displays the menu screen SC3. When the user ID notified by the user management unit 114 is “−1”, the display operation control unit 112 controls the display operation unit 103 to display a screen that includes information indicating that the authentication has failed instead of the menu screen SC3, which represents the operation menu after login.

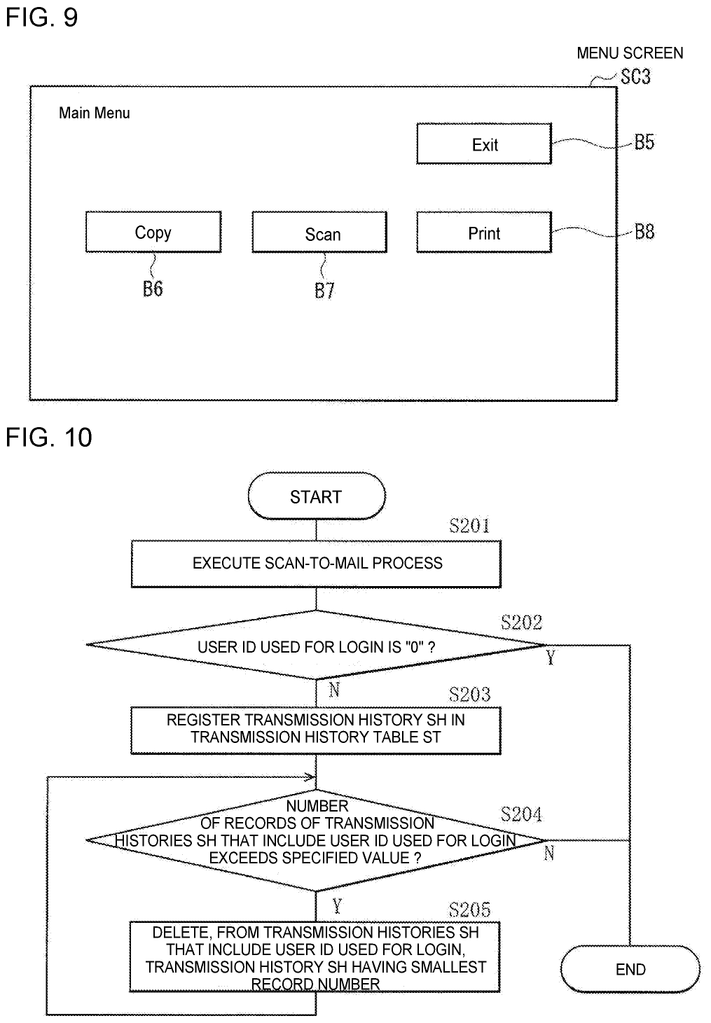

FIG. 9 is a diagram illustrating a view of an example of the menu screen SC3. The menu screen SC3 has buttons: an “Exit” button B5, a “Copy” button B6, a “Scan” button B7, and a “Print” button B8. The “Exit” button B5 is used to log out and also to end the display of the menu screen SC3 to return to the standby screen SC1. The “Copy” button B6 is a button for performing various processes for the copy operation. The “Scan” button B7 is a button for performing various processes for the scanning operation. The “Print” button B8 is a button for performing various processes for the image forming operation. That is, the multi-function peripheral device 100 can perform, based on a user operation received on the menu screen SC3, copying, scanning, and image forming operations.

This is the end of this flow.

(Scan-to-Mail Processing)

FIG. 10 is a diagram illustrating an example of the scan-to-mail process of the multi-function peripheral device 100. In this example, when receiving a user operation to the “Scan” button B7 on the menu screen SC3, the display operation unit 103 displays a screen displaying various operation options for scanning, and displays, based on a user operation on this screen, a scan-to-mail screen SC4 to start the scan-to-mail process. This operation is described in detail below.

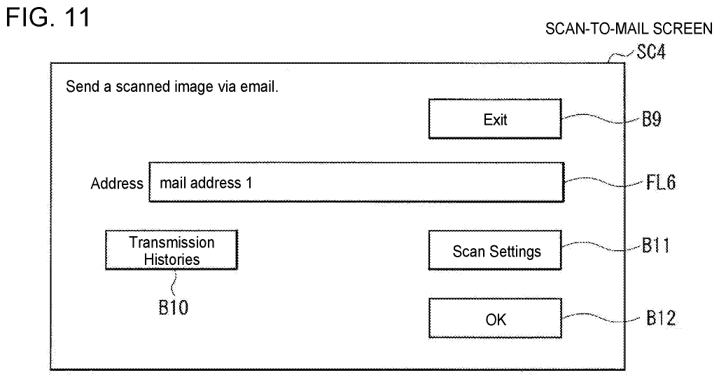

FIG. 11 is a diagram illustrating an example of the scan-to-mail screen SC4. The scan-to-mail screen SC4 includes an “Exit” button B9, a destination field FL6, a “Transmission History” button B10, a “Scan Settings” button B11, and an “OK” button B12. The “Exit” button B9 is the button for exiting the scan-to-mail screen SC4. The destination field FL6 is used to specify the destination to which the email with the image file attachment is sent. In the initial state, if there is one or more transmission histories SH that include the user ID same as the user ID currently used for the login in the transmission history table ST, the transmission destination(s) of the transmission history SH whose transmission date and time is the latest among the one or more transmission histories SH is entered in the destination field FL6. When the display operation unit 103 receives a user operation on the destination field FL6, the display operation control unit 112 generates, based on the instruction from the display operation unit 103, the destination information AD, and displays the destination information AD in the destination field FL6 in the scan-to-email screen SC4. The “Transmission History” button B10 is a button to display a transmission history screen SC5 which displays one or more transmission histories SH that include the user ID currently used for the login. When the user authentication is performed in the non-authentication method, the user cannot operate the “Transmission History” button B10. The “Scan Settings” button B11 is a button for making various settings for the scanning operation. The “OK” button B12 is the button for executing the scan-to-email process.

First, when receiving a user operation on the “OK” button B12 in the scan-to-mail screen SC4 illustrated in FIG. 11, the multi-function peripheral device 100 executes the scan-to-mail process (step S201). Specifically, for example, when the display operation unit 103 receives a user operation on the OK button B12 in the scan-to-mail screen SC4, the display operation control unit 112 notifies the scan execution unit 117 of the operation instruction according to the “OK” button B12. The scan execution unit 117 controls, based on this operation instruction, the scan control unit 124, the image file generation unit 121, and the mail transmission unit 122. The scan control unit 124 controls, based on the instruction from the scan execution unit 117, the scanning device 105 to perform the scanning operation, thereby causing the scanning device 105 to perform the scanning operation. The scan control unit 124 then acquires the image data. The image file generation unit 121 generates, based on the instruction from the scan execution unit 117, an image file using the image data acquired by the scan control unit 124. The mail transmission unit 122 generates, based on the instruction from the scan execution unit 117, an email with the image file generated by the image file generation unit 121, and transmits, based on a user operation on the destination field FL6, the email to the destination information AD generated by the display operation control unit 112. The mail transmission unit 122 then notifies the scan execution unit 117 of the result of transmitting the email including the destination information AD.

Next, the scan execution unit 117 obtains the user ID currently used for the login from the display operation control unit 112 and determines whether the user ID currently used for the login is 0 or not (step S202). If the user ID currently used for the login is 0 (“Y” in step S202), the process ends. In other words, when the display operation unit 103 receives the “Temporary Use” button B2 in the standby screen SC1, the user ID currently used for the login is 0, so the transmission history management unit 123 does not register a new transmission history SH that includes destination information AD in the user management table UT.

If the user ID currently used for the login is not 0 (“N” in step S202), the transmission history management unit 123 registers, based on an instruction from the scan execution unit 117, a transmission history SH in the transmission history table ST (step S203). Specifically, for example, the transmission history management unit 123 registers a new transmission history SH that includes the destination information AD in the transmission history table. In the new transmission history SH, the user ID used for the login is registered in the “user ID”, the destination information AD is registered in the “transmission destination”, and the date and time when the email is sent by the mail transmission unit 122 is registered in the “Transmission Date and Time”.

Next, the transmission history management unit 123 determines whether the number of records of the transmission histories SH that include the user ID same as the user ID currently used for the login in the transmission history table ST exceeds the specified value (step S204). In the transmission history table ST, if the number of records of the transmission histories SH that include the user ID same as the user ID currently used for the login is less than or equal to the specified value (“N” in step S204), this process ends.

In the transmission history table ST, if the number of records of the transmission histories SH that include the user ID same as the user ID currently used for the login exceeds the specified value (“Y” in step S204), the transmission history management unit 123 deletes, from the transmission histories SH that include the user ID same as the user ID currently used for the login, the transmission history SH having the smallest record number (step S205). Then, the process returns to Step S204.

This is the end of this flow.

Thus, the multi-function peripheral device 100 performs, based on user operations, the user authentication and the scan-to-email process, and registers the user management information UI in the user management table UT and transmission history SH in the transmission history table ST. In this example, the same user performs the user authentication processes based on different authentication information, and each of the different authentication information is registered in the user management table UT. Further, the same user performs the scan-to-email process based on each of the three pieces of authentication information, and each of the transmission histories SH is registered in the transmission history table ST. Specifically, for example, firstly, the multi-function peripheral device 100 performs the user authentication process and the scan-to-mail process based on the authentication information AUC, which is “AAAAAAAAAAAAAAAAAAA”. Thereafter, the multi-function peripheral device 100 performs the user authentication process and the scan-to-mail process based on the authentication information AUC, which is “BBBBBBBBBBBBBBBBB”. Then, the multi-function peripheral device 100 further performs the user authentication and the scan-to-mail process based on the authentication information AUP whose user name is “temp1” and password is “pass3”.

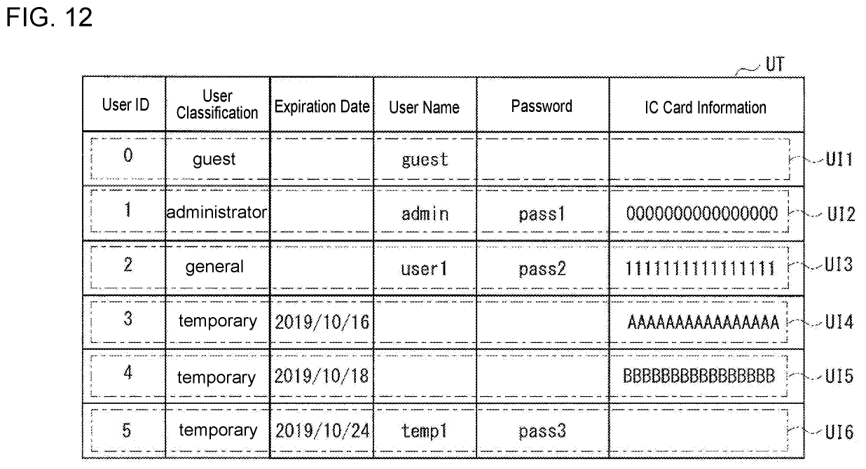

FIG. 12 is diagram illustrating an example of the user management table UT. The user management table UT includes one or more pieces of user management information UI (in this example, user management information UI1 to UI6). In this example, the user management information UI4 includes the authentication information AUC, which is “AAAAAAAAAAAAAAAAAAA”. The user management Information UI5 includes the authentication information AUC, which is “BBBBBBBBBBBBBBBBB”. The user management information UI6 includes the authentication information AUP whose user name is “temp1” and whose password is “pass3”.

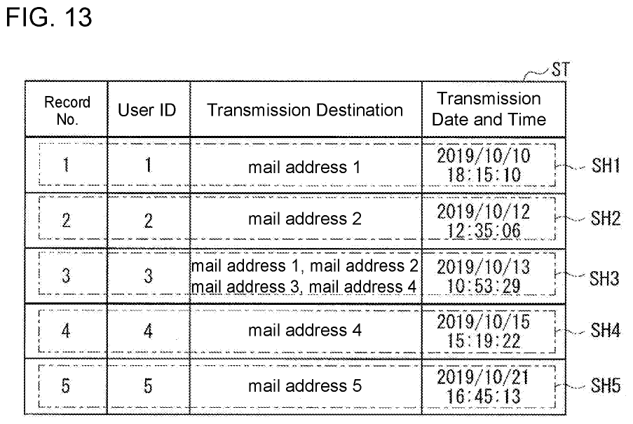

FIG. 13 is a diagram illustrating an example of the transmission history table ST. The transmission history table ST contains one or more transmission histories SH (in this example, transmission histories SH1 to SH5). In this example, the transmission history SH3 is associated with the authentication information AUC, which is “AAAAAAAAAAAAAAAAAAA”. The transmission history SH4 is associated with the authentication information AUC, which is “BBBBBBBBBBBBBBBBB”. The transmission history SH5 is associated with the authentication information AUP whose user name is “temp1” and password is “pass3”.

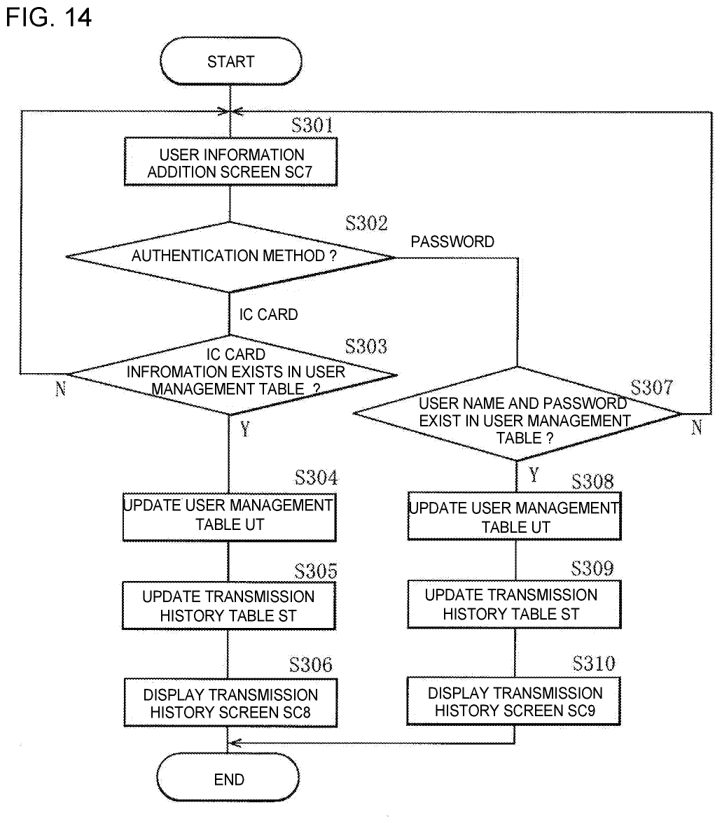

FIG. 14 is a diagram illustrating an example of a process in which the multi-function peripheral device 100 correspond two pieces of authentication information to each other in the scan-to-email process of the multi-function peripheral device 100. In this example, the multi-function peripheral device 100 further performs the user authentication and the scan-to-email process based on the authentication information AUC, which is “AAAAAAAAAAAAAAAAAAA”. In doing so, the multi-function peripheral device 100 performs the process of corresponding the two pieces of authentication information to each other. When receiving a user operation on the “Transmission History” button B10 on the scan-to-mail screen SC4, the display operation unit 103 displays the transmission history screen SC5 that displays one or more transmission histories SH for designating, from the one or more transmission histories SH, the destination(s) to which the email is to be sent, to start the process. This operation is described in detail later.

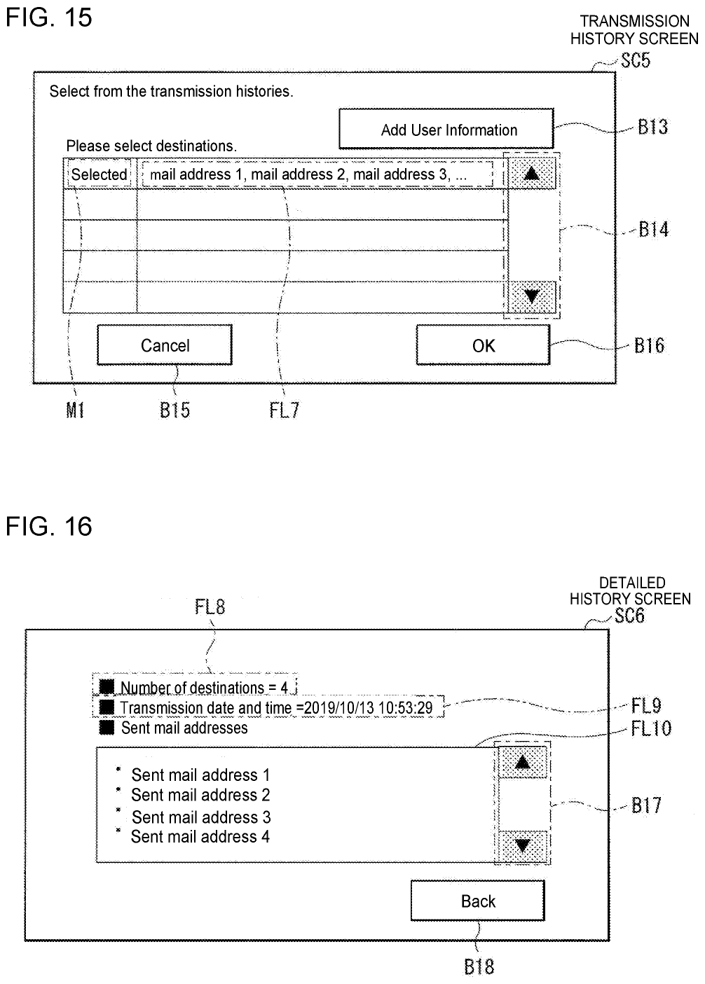

FIG. 15 is a diagram illustrating an example of the transmission history screen SC5. The transmission history screen SC5 has an “Add User Information” button B13 a scroll button B14, a “Cancel” button B15, an “OK” button B16, a selection mark M1, and a destination field FL7. The “Add User Information” button B13 is a button for corresponding two pieces of authentication information to each other. The scroll button B14 is a button for scrolling the contents of the destination field FL7. In this example, the user cannot use the scroll button B14. The cancel button B15 is used to cancel specifying, from one or more transmission histories SH, a destination(s) to which the email is to be transmitted. The OK button B16 is a button for deciding the destination(s) to which the email is to be transmitted from the selected transmission history SH. The selection mark M1 is a mark indicating that the destination(s) has been selected as the destination(s) to which the email is to be transmitted. The destination field FL7 is a field for displaying the transmission destination(s) of one or more transmission histories SH that include the user ID currently used for the login. In the example illustrated in FIG. 15, when the destinations of the transmission history SH3 are displayed in the destination field FL7, there is no enough space to display “mail address 4” in the destination field FL7 and thus “ . . . ” is displayed at the end of the destination field FL7. When receiving a user operation on the destination field FL7, the display operation unit 103 displays a detailed history screen SC6 to display the details of the transmission history SH.

FIG. 16 is a diagram illustrating an example of the detailed history screen SC6. The detailed history screen SC6 includes a destination count field FL8, a date and time field FL9, a destination field FL10, a scroll button B17, and a “Back” button B18. The destination count field FL8 is a field for displaying the number of destinations in the transmission history SH selected in the destination field FL7. The transmission date and time field FL9 is used to display the date and time of the transmission history SH selected in the destination field FL7. The destination field FL10 is afield for displaying the transmission destination(s) of the transmission history SH selected in the destination field FL7. The scroll button B17 is a button for scrolling the contents of the destination field FL10. In this example, the user cannot use the scroll button B17. The “Back” button B18 is a button to exit the detailed history screen SC6 and return to the transmission history screen SC5.

First, when receiving a user operation on the “Add User Information” button B13 in the transmission history screen SC5 illustrated in FIG. 15, the display operation unit 103 displays the user information addition screen SC7 for corresponding the two pieces of authentication information to each other (Step S301).

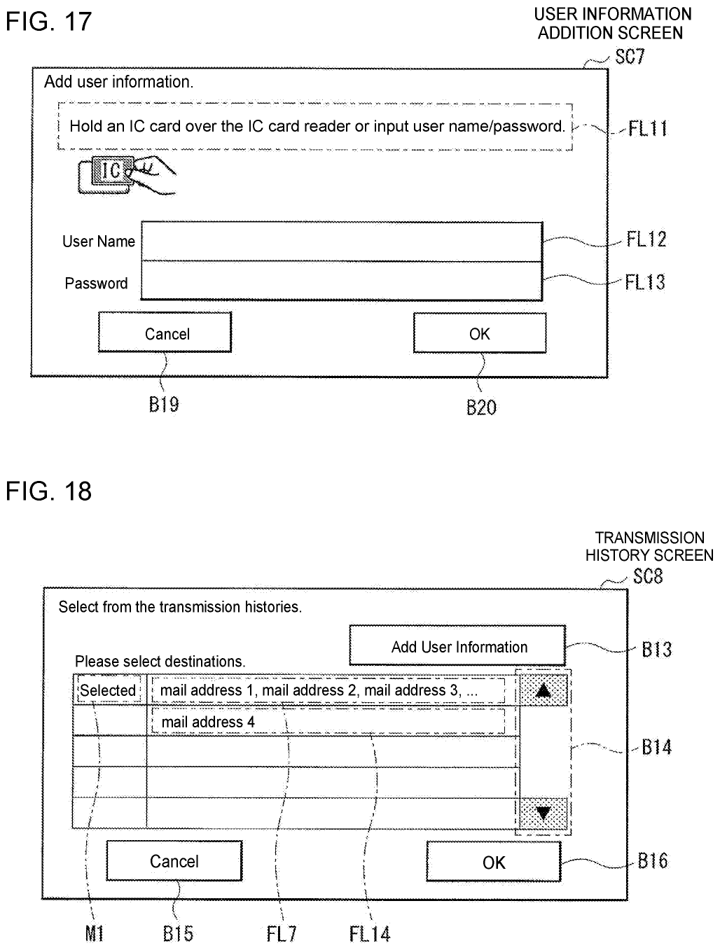

FIG. 17 is a diagram illustrating an example of the user information addition screen SC7. The user information addition screen SC7 has an information field FL11, a user name field FL12, a password field FL13, a “Cancel” button B19, and an “OK” button B20. The information field FL11 is used to prompt the user to input the authentication information AUC by holding the IC card over the IC card reader 200, or to input a user name and a password. The user name field FL12 is afield for inputting a user name. The password field FL13 is afield for inputting a password. The “Cancel” button B19 is a button to cancel to correspond the two pieces of authentication information to each other. The “OK” button B20 is a button for deciding to correspond the two pieces of authentication information to each other.

Next, the authentication unit 115 determines the authentication method, based on the operation instruction notified by the display operation control unit 112, the authentication information AUP notified by the display operation control unit 112, or the authentication information AUC notified by the USB communication control unit 111 (step S302). Specifically, for example, when the IC card reader 200 receives a user operation (reads the IC card information from the IC card), the IC card reader 200 generates authentication information AUC, which is the IC card information, and transmits the authentication information AUC to the multi-function peripheral device 100. The USB communication control unit 111 then notifies the authentication information AUC to the authentication unit 115. When the authentication information AUC is notified to the authentication unit 115, the authentication method is the IC card method. The display operation unit 103 receives user operations in the user name field FL12 and in the password field FL13 on the user information addition screen SC7, and further receives a user operation to the OK button B20 on the user information addition screen SC7. The display operation control unit 112 generates authentication information AUP based on the instruction from the display operation unit 103, and notifies the authentication unit 115 of this authentication information AUP and the operation instruction according to the “OK” button B20. When the authentication information AUP and the operation instruction are notified to the authentication unit 115 the authentication method is the password method. If the authentication method is the password method (“password method” in step S302), the process proceeds to step S307.

When the authentication method is the IC card method (“IC card” in step S302), the authentication unit 115 determines whether the IC card information, which is the authentication information AUC, is in the user management table UT (step S303). If the IC card information is not in the user management table UT (“N” in step S303), the process returns to step S301.

If the IC card information is in the user management table UT (“Y” in step S303), the user management unit 114 updates the user management table UT based on the instruction from the authentication unit 115 (step S304). Specifically, for example, if the IC card information whose authentication information AUC is “BBBBBBBBBBBBBBBBBBBBBBBB” is in the user management table UT, the user management unit 114 updates the user ID of the user management information UI5 to “3”, which is the user ID currently used for the login.

Next, the transmission history management unit 123 updates the transmission history table ST based on the instruction from the authentication unit 115 (step S305). Specifically, for example, the transmission history management unit 123 updates the user ID of the transmission history SH4 to “3”, which is the user ID currently used for the login. The transmission history management unit 123 then notifies the display operation unit 103 of an update completion notice. That is, in steps S304 and S305, the user management unit 114 and the transmission history management unit 123 correspond the authentication information AUC of the user management information UI5 to the authentication information AUC of the user management information UI4.

Next, based on the notification of the completion of the update of the transmission history management unit 123, the display operation unit 103 displays, in step S306, the transmission history screen SC8 displaying the transmission histories SH associated with two pieces of the authentication information AUC corresponded to each other in steps S304 and S305. Specifically, for example, the display operation control unit 112 controls the display operation unit 103 to display the transmission history screen SC8 based on the notification of the completion of the update of the transmission history management unit 123. The display operation unit 103 then displays the transmission history screen SC8.

FIG. 18 is a diagram illustrating an example of the transmission history screen SC8. The transmission history screen SC8 has a destination field FL14. The destination field FL14 is a field for displaying the transmission destination(s) of one or more transmission histories SH associated with the corresponded authentication information AUC. In this example, the destination field FL14 displays the transmission destination(s) of the transmission history SH that was updated in step S305. Even if the user logs in again using the user ID of the user management information UI4 or the updated user management information UI5, the multi-function peripheral device 100 displays, when receiving a user operation on the “Transmission History” button B10 in the scan-to-mail screen SC4, the transmission history screen SC8 instead of the transmission history screen SC5.

If the authentication method is the password method (“password” in step S302), the authentication unit 115 determines whether a set of the user name and the password, which is the authentication information AUP, is in the user management table UT (step S307). When the set of the user name and the password is not in the user management table UT (“N” in step S307), the process returns to step S301.

If the set of the user name and the password exists in the user management table UT (“Y” in step S307), the user management unit 114 updates the user management table UT based on the instruction from the authentication unit 115 (step S308). Specifically, for example, if the set of the user name of “temp1” and the password of “pass3” of the authentication information AUP exists in the user management table UT, the user management unit 114 updates the user ID in the user management Information UI6 to “3”, which is the user ID currently used for the login. This causes the user management information UI6 to be updated to the user management information UI6R, as illustrated in FIG. 3.

Next, the transmission history management unit 123 updates the transmission history table ST based on the instruction from the authentication unit 115 (step S309). Specifically, for example, the transmission history management unit 123 updates the user ID of the transmission history SH5 to “3”, which is the user ID currently used for the login. This causes the transmission history SH5 to be updated to the transmission history SH5R, as illustrated in FIG. 4. The transmission history management unit 123 then notifies the display operation unit 103 of the update completion notice. That is, in steps S308 and S309, the user management unit 114 and the transmission history management unit 123 correspond the authentication information AUP of the user management information UI6 to the authentication information AUC of the user management information UI4.

Next, based on the notification of the completion of the update of the transmission history management unit 123, the display operation unit 103 displays, in step S310, a transmission history screen SC9 displaying the transmission histories SH associated with the two pieces of authentication information AUC corresponded to each other in steps S308 and S309. Specifically, for example, based on the notification of the completion of the update of the transmission history management unit 123, the display operation control unit 112 controls the display operation unit 103 to display the transmission history screen SC8. The display operation unit 103 then displays the transmission history screen SC9.

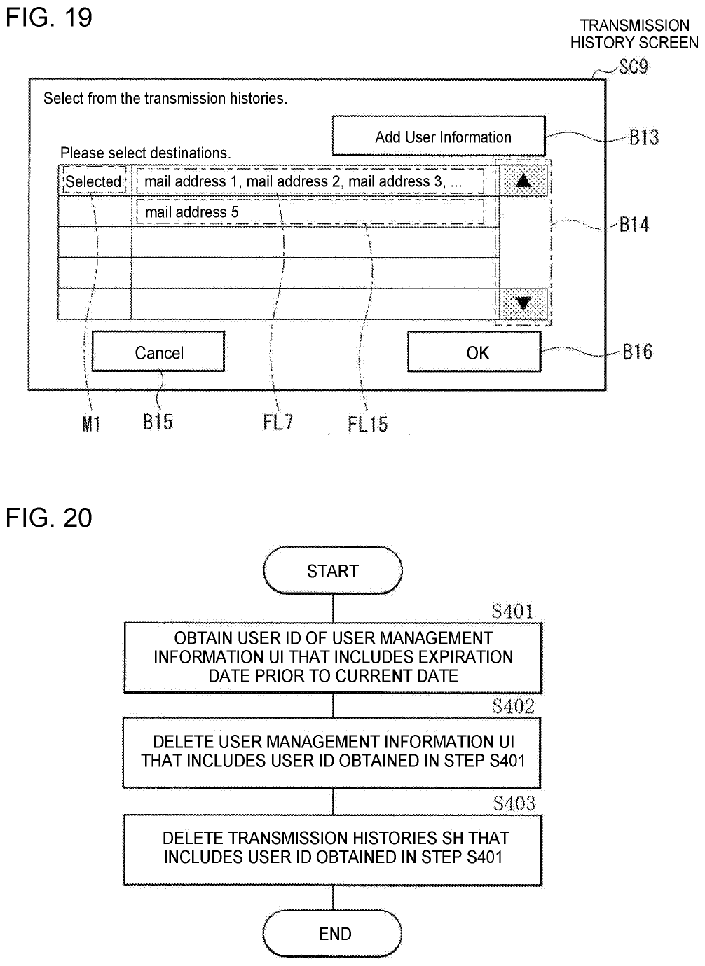

FIG. 19 is a diagram illustrating an example of the transmission history screen SC9. The transmission history screen SC9 includes a destination field FL15. The destination field FL15 is a field for displaying the transmission destination(s) of one or more transmission histories SH associated with to the corresponded authentication information AUP. In this example, the destination field FL15 displays the transmission destination(s) of the transmission history SH5R that was updated in step S309. Even if the user logs in again with the user ID of the user management information UI4 or the user management information UI6R, the multi-function peripheral device 100 displays the transmission history screen SC9 instead of the transmission history screen SC5 when receiving a user operation on the “Transmission History” button B10 in the scan-to-email screen SC4.

This is the end of this flow.

In this example, the multi-function peripheral device 100 corresponds the authentication information AUC currently used for the authentication to authentication information AUC or authentication information AUP other than the authentication information AUC currently used for the authentication. However, the disclosure is not limited to this example. Instead, for example, the multi-function peripheral device 100 may correspond the authentication information AUP currently used for the authentication to authentication information AUC or authentication information AUP other than the authentication information AUP currently used for the authentication. Even in this case, as illustrated in FIG. 14, the multi-function peripheral device 100 performs a process of corresponding two pieces of authentication information to each other in the scan-to-email process of the multi-function peripheral device 100.

(Daily Changing Process)

FIG. 20 is a diagram illustrating an example of the daily changing process of the multi-function peripheral device 100. In the daily changing process, the multi-function peripheral device 100 updates the user management table UT and the transmission history table ST at the timing of activation of the multi-function peripheral device 100 and at the timing when the date changes. This operation is described in detail below.

First, the control unit 140 obtains the user ID of the user management information UI that includes the expiration date prior to the current date in the user management table UT (step S401). Specifically, for example, the daily change processing unit 116 instructs the user management unit 114 to obtain the user ID of the user management information UI that includes the expiration date prior to the current date in the user management table UT. For example, if the current date is 10/17/2019 the user management unit 114 obtains the user ID of the user management information UI3, which has the expiration date of “10/16/2019” or earlier. That is, in this example, the user management unit 114 obtains the user ID of “3”.

Next, the control unit 140 deletes the user management information UI that includes the user ID obtained in step S401 from the user management table UT (step S402). Specifically, for example, the daily change processing unit 116 instructs the user management unit 114 to delete the user management information UI that includes the user ID obtained in step S401 in the user management table UT. In this example, since the user ID obtained in step S401 is “3”, the user management unit 114 deletes, from the user management table UT, the user management information UI4 having the user ID of “3”. At this time, even if the user ID is “3”, the user management unit 114 does not delete the user management information UI that has the user ID of “3” if the expiration date thereof is after 10/17/2019. In other words, the transmission history management unit 123 does not delete the user management information UI6R.

Next, the control unit 140 deletes the history information SH that includes the user ID obtained in step S401 in the user management table UT (step S403). Specifically, for example, the daily change processing unit 116 instructs the transmission history management unit 123 to delete the transmission history SH that includes the user ID obtained in step S401 in the transmission history table ST. Since the user ID obtained in step S401 is “3”, the transmission history management unit 123 deletes the transmission history SH3 whose user ID is “3” in the transmission history table ST. At this time, even if the user ID is “3”, the transmission history management unit 123 does not delete the transmission history SH that has the user ID of “3” if the transmission date and time thereof is after 10/17/2019. In other words, the transmission history management unit 123 does not delete the transmission history SH5R.

This is the end of this flow.

Thus, in the scan system 1, when the multi-function peripheral device 100 authenticates by the IC card method or the password method, the transmission history management unit 123 registers the transmission history SH thereof in the transmission history table ST. On the other hand, when the multi-function peripheral device 100 authenticates by the non-authentication method, the transmission history management unit 123 does not register the transmission history SH thereof in the transmission history table ST. This allows the user to select whether or not to register the transmission history SH in the multi-function peripheral device 100. Accordingly, for example, when the multi-function peripheral device 100 sends an email using destination information AD, which the user plans to use in the future, the transmission history SH of the email is registered in the multi-function peripheral device 100. On the other hand, when the multi-function peripheral device 100 sends an email using destination information AD, which the user does not plan to use in the future, the transmission history SH is not registered in the multi-function peripheral device 100. Therefore, for example, when the display operation unit 103 displays the transmission history screen SC5, the number of the destination information AD displayed can be reduced, thus improving the user convenience.

That is, for example, in a case where the multi-function peripheral does not allow the users to select whether or not to register the transmission history thereof and all the transmission histories are registered in the multi-function peripheral device, the users using the multi-function peripheral device can see all the transmission histories of an indefinite number of users when using the scan-to-email function. For example, when the multi-function peripheral device is installed in a public place, such as a library, where the device is expected to be used by an unspecified number of users, it may be desirable to improve security. In addition, when the multi-function peripheral device authenticates based on the user authentication information by registering in advance the authentication information of a user whose use is permitted by the administrator, security can be improved by preventing the multi-function peripheral device from displaying transmission histories of users other than this user. In this case, the administrator needs to register the authentication information of users in advance. Thus, it may be desirable to improve the convenience of the administrator, especially if an unspecified number of users are expected to use the multi-function peripheral device.

On the other hand, in the scan system 1, the display operation control unit 112 generates the authentication information AUP and the destination information AD based on the instruction from the display operation unit 103, and the user management unit 114 and the transmission history management unit 123 register the authentication information AUP and register the destination information AD in association with the authentication information AUP. Then, the display operation control unit 112 controls to display the destination information AD registered by the transmission history management unit 123 on the display operation unit 103, in conjunction with the generation of the authentication information AUP by the display operation control unit 112. With this configuration in this scan system 1, even in the case where an unspecified number of users can use the multi-function peripheral device 100, when a user permits to record the operation histories made by the user without the administrator having to register the user, the user can use the transmission histories SH associated with the authentication information of the user whereas anyone other the user cannot use the transmission histories SH associated with the authentication information of the user. Thus, for example, the user can select an email address(es) from the transmission histories SH that he or she has registered, reducing the number of choices of addresses, thus improving security and increasing the user convenience.

In the scan system 1, the IC card reader 200 generates the authentication information AUC, the user management unit 114 and the transmission history management unit 123 register the authentication information AUC and associate the authentication information AUC with the authentication information AUP, and the display operation control unit 112 displays on the display operation unit 103 the destination information AD contained in the transmission histories SH associated with the authentication information AUP, in response to the generation of the authentication information AUC by the IC card reader 200. With this configuration, for example, when the multi-function peripheral device 100 performs the user authentication based on the authentication information AUC, the user can refer to the destination information AD contained in the transmission histories SH associated with the authentication information AUP and the authentication information AUC other than the authentication information AUC currently used for the user authentication. This can improve the convenience for the user.

In particular, in the scan system 1, the display operation control unit 112 is configured, in response to the generation of the authentication information AUC by the IC card reader 200, to display on the display operation unit 103 the destination information AD contained in the transmission histories SH associated with the authentication information AUP and the destination information AD contained in the transmission histories SH associated with the authentication information AUC. With this configuration, for example, when the authentication information AUP is corresponded to the authentication information AUC, the user can refer to the destination information AD in the transmission histories SH associated with the authentication information AUP and the destination information AD in the transmission histories SH associated with the authentication information AUC on the same screen. This makes it more convenient for the user.

Further, in the scan system 1, the display operation control unit 112 is configured, in response to the generation of the authentication information AUP by the display operation control unit 112, to display, on the display operation unit 103, the destination information AD contained in the transmission histories SH associated with the authentication information AUP and also the destination information AD contained in the transmission histories SH associated with the authentication information AUC that is corresponded to the authentication information AUP by the user management unit 114 and the transmission history management unit 123. That is, when either of the authentication information AUC or the authentication information AUP is used after the authentication information AUC and the authentication information AUP are corresponded to each other, the display operation control unit 112 displays the transmission histories SH associated with both of the authentication information AUC and the authentication information AUP. This allows users to select an easy-to-use authentication method each time without wondering whether they should use the IC card authentication method or the password authentication method, thus improving the user convenience.

In the scan system 1, the display operation control unit 112 generates the authentication information AUP based on the instruction from the display operation unit 103, and the IC card reader 200 generates the authentication information AUC, which is the IC card information, by receiving the user operation. Then, the multi-function peripheral device 100 authenticates the user based on the authentication information AUP or the authentication information AUC. This means that, for example, even if the user happens not to carry his or her IC card with him or her unintentionally, the multi-function peripheral device 100 can authenticate the user with the user name and password, allowing the user to use the transmission histories SH associated with the authentication information AUP and the authentication information AUC, and thus improving the user convenience.

Further, in the scan system 1, the transmission history management unit 123 deletes one or more pieces of the user management information UI that includes the authentication information AUC or the authentication information AUP registered by the user management unit 114, at the timing when the multi-function peripheral device 100 is activated and at the timing when the date changes. This allows the scan system 1 to increase ease of installation and maintenance, as well as increase security because it eliminates the need to protect data for a long period of time, for example.

In the scan system 1, the display operation control unit 112 causes the display operation control unit 103 to display information indicating that the transmission history management unit 123 will register a transmission history SH including destination information AD, in the information field FL2 of the standby screen SC1 before the display operation control unit 112 generates the authentication information AUP. This allows the scan system 1 to improve the user convenience because the user understands beforehand that a transmission history SH is registered. Therefore, the user can input destination information AD without hesitation, for example.

[Effects]

As described above, in an embodiment described above, when the multi-function peripheral device authenticates by the IC card method or the password method, a transmission history is registered in the transmission history table. On the other hand, when the multi-function peripheral device authenticates by the non-authentication method, no transmission history is registered in the transmission history table. This allows the user to choose whether or not to register a transmission history in the multi-function peripheral device. Therefore, for example, when the display operation unit displays the transmission history screen, the number of pieces of destination information to be displayed can be reduced, thus increasing the user convenience.

In an embodiment described above, the display operation control unit generates authentication information AUP and destination information based on the instruction from the display operation unit, and the user management unit and the transmission history management unit register the authentication information AUP and register the destination information in association with the authentication information AUP. Then, when the display operation control unit generates the authentication information AUP, the destination information registered by the transmission history management unit is displayed on the display operation unit. Accordingly, even in the case where an unspecified number of users can use the multi-function peripheral device, a user can use the transmission histories associated with the authentication information of the user without the administrator having to register the user, and users other than the user cannot use the transmission histories of the user. This increases security and the user convenience.

In an embodiment described above, the IC card reader generates the authentication information AUC, the user management unit and the transmission history management unit register the authentication information AUC and associate the authentication information AUC with the authentication information AUP, and the display operation control unit displays on the display operation unit the destination information contained in the transmission histories corresponding to the authentication information AUP corresponding to the authentication information AUC, along with the generation of the authentication information AUC with the IC card reader. This allows the user to refer to the destination information contained in the transmission histories associated with the authentication information AUC and the authentication information AUP other than the authentication information AUC currently used for the authentication, thus improving the user convenience.

In an embodiment described above, along with the generation of the authentication information AUC by the IC card reader, the destination information included in the transmission histories associated with the authentication information AUP as well as the destination information included in the transmission histories associated with the authentication information AUC are displayed. Therefore, the destination information AD included in the transmission histories associated with the authentication information AUP and the destination information AD included in the transmission histories associated with the authentication information AUC can be referenced on the same screen, thereby improving the user convenience.

In an embodiment described above, in response to the generation of the authentication information AUP by the display operation control unit, the display operation unit displays the destination information contained in the transmission histories associated with the authentication information AUP and also the destination information contained in the transmission histories associated with the authentication information AUC that is corresponded to the authentication information AUP by the user management unit and the transmission history management unit. Accordingly, whichever authentication method the user uses, the destination information contained transmission histories in relation with the user are displayed. This allows the user to select an authentication method that is easy to use each time, thus improving the user convenience.

In an embodiment described above, the display operation control unit generates the authentication information AUP based on the instruction from the display operation unit, the IC card reader generates the authentication information AUC upon the user operation on the IC card reader, and the multi-function peripheral device can authenticate the user based on either of the authentication information AUP or the authentication information AUC. Accordingly, for example, even if the user happens not to carry his or her IC card unintentionally, the multi-function peripheral device can authenticate the user with the user name and password, allowing the user to use the transmission histories associated with both of the authentication information AUP and the authentication information AUC, thus improving the user convenience.

In an embodiment described above, one or more pieces of the user management information that includes the authentication information registered by the user management unit is deleted at the timing when the multi-function peripheral device is activated and at the timing when the date changes. This can increase ease of installation and maintenance, as well as security.

In an embodiment described above, before the display operation control unit generates the authentication information, the display operation unit displays information indicating that the transmission history management unit will register a transmission history that includes destination information. This can further increase the user convenience.

[Modification 1]

In an embodiment described above, the IC card reader 200 receives the authentication information AUC, which is the IC card information. However, the disclosure is not limited to this. For example, in a modification, a biometric information acquisition device may receive authentication information such as a fingerprint, finger vein, palm, or facial information, for example, as a substitute for the IC card reader.

[Modification 2]

In an embodiment described above, the transmission history management unit 123 maps the transmission histories SH associated with the authentication information AUP or the authentication information AUC currently used for the authentication to the transmission histories SH associated with the authentication information other than the authentication information currently used for the authentication. However, the disclosure is not limited to this. For example, in a case where setting information such as scan settings, copy settings, etc., or operation log information such as print history is associated with the authentication information AUP and the authentication information AUC, the setting information or the operation log information associated with the authentication information AUP or the authentication information AUC currently used for the authentication may be mapped to the setting information or the operation log information associated with the authentication information other than the authentication information currently used for the authentication. For example, in a case where the setting information is uniquely identified to the user management information UI, the setting information associated with the authentication information AUP or the authentication information AUC currently used for the authentication and the setting information associated with the authentication information other than the authentication information AUP or AUC currently used for the authentication are merged into the same setting information.

[Modification 3]

In an embodiment described above, the multi-function peripheral device 100 authenticates the user upon receiving the user operation on the display operation unit 103 or the IC card reader 200. However, the disclosure is not limited to this. For example, in a modification, when both the display operation unit 103 and the IC card reader 200 receive user operations, the multi-function peripheral device may map (correspond) the authentication information AUC generated by the IC card reader 200 to the authentication information AUP generated by the display operation control unit 112, and authenticate the user.

[Modification 4]

In an embodiment described above, the multi-function peripheral device 100 authenticates the user based on the user operation, and then performs the scan-to-email process based on the user operation on the menu screen SC3. However, the disclosure is not limited to this. For example, in a modification, the multi-function peripheral device 100 may perform the scan-to-email process based on the user operation on the menu screen SC3, and then perform the user authentication based on the user operation.

[Modification 5]

In an embodiment described above, when the user ID currently used for the login is not “0”, the transmission history management unit 123 registers the transmission history SH in the transmission history table ST based on the instruction from the scan execution unit 117 as indicated in step S203. However, the disclosure is not limited to this. For example, in a modification, the mail transmission unit may inquire of the recipient who sent the email whether the transmission history SH should be registered in the transmission history table ST, and the transmission history management unit may register the transmission history SH in the transmission history table ST based on the result of this inquiry.

[Modification 6]

In an embodiment described above, when the multi-function peripheral device 100 performs the user authentication by the non-authentication method, the transmission history management unit 123 does not register the transmission history SH in the transmission history table ST. However, the disclosure is not limited to this. For example, in a modification, when the multi-function peripheral device 100 performs the user authentication by the non-authentication method, the transmission history SH may be registered in the transmission history table ST while the user is logged in, and the registered transmission history SH may be deleted once the user logs out.

[Other Modifications]

Moreover, two or more of the modifications described above may be combined.

Although the disclosure has been explained in the foregoing with one or more embodiments and modifications, the disclosure is not limited to the one or more embodiments and modifications, and various alternations or variations are possible.

For example, in an embodiment described above, the IC card reader 200 is connected to the multi-function peripheral device 100 via the USB, but the disclosure is not limited to this. Instead, the IC card reader 200 may be connected to the multi-function peripheral device 100 through another connection method. For example, the IC card reader 200 may be connected by short-range wireless communication based on a standard such as Bluetooth (registered trademark).

Further, in one or more embodiments and modifications described above and the like, the technology is applied to the multi-function peripheral device 100, but the disclosure is not limited to this, and instead may be applied to a single function printer, a single function fax machine, a single function scanner, or the like, for example.

The invention includes other embodiments in addition to the above-described one or more embodiments and modifications without departing from the spirit of the invention. The one or more embodiments and modifications described above are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An information processing apparatus comprising:
an operation unit that receives user operations;
a data generation unit that generates first user information, first instruction information and second user information based on instructions from the operation unit based on user operations;
a registration unit that registers the first user information, registers the first instruction information in association with the first user information, registers the second user information, and corresponds the registered first user information to the second user information; and
a display control unit that displays on the display unit, in response to the generation of the first user information by the data generation unit, the first instruction information registered by the registration unit, and displays on the display unit, in response to the generation of the second user information by the data generation unit, the first instruction information associated with the first user information to which the registration unit has corresponded the second user information.

2. The information processing apparatus according to claim 1, wherein
the data generation unit generates second instruction information based on an instruction from the operation unit, and
the registration unit registers the second instruction information in association with the second user information, and
the display control unit displays on the display unit, in response to the generation of the second user information by the data generation unit, the second instruction information associated with the second user information in addition to the first instruction information.

3. The information processing apparatus according to claim 2, wherein
the display control unit displays on the display unit, in response to the generation of the first user information by the data generation unit, the second instruction information associated with the second user information to which the registration unit has corresponded the first user information, in addition to the first instruction information.

4. The information processing apparatus according to claim 1, wherein
the registration unit corresponds the first user information to the second user information, in such a manner that when the data generation unit generates the second user information, the data generation unit further generates the first user information based on an instruction from the operation unit, thereby corresponding the first user information to the second user information, and
the registration unit corresponds the first user information to the second user information, in such a manner that when the data generation unit generates the first user information, the data generation unit further generates the second user information based on an instruction from the operation unit, thereby corresponding the first user information to the second user information.

5. The information processing apparatus according to claim 1, wherein
the operation unit includes a first operation unit that receives a user operation and a second operation unit that receives a user operation, and
the data generation unit includes: a first data generation unit that generates, based on an instruction from the first operation unit, the first user information and the first instruction information, and a second data generation unit that generates, based on an instruction from the second operation unit, the second user information.

6. The information processing apparatus according to claim 5, wherein
at least one of the first operation unit and the second operation unit comprises an IC card reader.

7. The information processing apparatus according to claim 1, wherein
each of the first user information and the second user information includes at least IC card information or a username and a password.

8. The information processing apparatus according to claim 1, wherein
the first instruction information includes information about an email address.

9. The information processing apparatus according to claim 1, wherein
the registration unit deletes the first user information registered by the registration unit at a predetermined timing.

10. The information processing apparatus according to claim 1, wherein
the display control unit displays information indicating that the registration unit will register the first instruction information on the display unit before the data generation unit generates the first user information.

11. An information processing apparatus comprising:
a data generation unit that generates user information used for user authentication and instruction information;
a registration unit that registers, when the data generation unit generates first user information and first instruction information and the user authentication is successful with the first user information, the first instruction information in association with the first user information, and corresponds, when the data generation unit generates second user information and user identification information of the first user information and user identification information of the second user information match with each other, the second user information to the registered first user information; and
a display control unit that displays on a display unit, in response to the generation of the second user information by the data generation unit, the first instruction information associated with the first user information corresponded to the second user information.

12. The information processing apparatus of claim 11, wherein
the data generation unit includes a first data generation unit and a second data generation unit, and
the user information generated by the first data generation unit and the user information generated by the second data generation unit differ from each other in a user authentication method.

13. The information processing apparatus of claim 11, wherein
the first user information and the second user information are different from each other in a user authentication method.
